(19) United States
(12) Patent Application Publication
(10) Pub. No.: US 2013/0034840 A1
(43) Pub. Date: Feb. 7, 2013

(54) SELECTING SURVEY QUESTIONS

(71) Applicants: Mary C. Burton, Springfield, IL (US); Deepa R. Nair, Atlanta, GA (US); Birgit Schmidt-Wesche, Pound Ridge, NY (US); Lauren Shupp, Blacksburg, VA (US); Peter Sohn, Chelmsford, MA (US)

(72) Inventors: Mary C. Burton, Springfield, IL (US); Deepa R. Nair, Atlanta, GA (US); Birgit Schmidt-Wesche, Pound Ridge, NY (US); Lauren Shupp, Blacksburg, VA (US); Peter Sohn, Chelmsford, MA (US)

(73) Assignee: INTERNATIONAL BUSINESS MACHINES CORPORATION, Armonk, NY (US)

(21) Appl. No.: 13/197,559

(22) Filed: Aug. 3, 2011

(51) Int. Cl. G09B 7/00

(52) U.S. Cl. 434/362

(57) ABSTRACT

For selecting survey questions, a response module receives responses to first questions relating to at least two qualities of at least two characteristics. A plot module generates a scatter plot of the at least two qualities for each characteristic. A selection module selects second questions targeted to characteristics with characteristic plot values for the at least two qualities in a specified region of the scatter plot.

### BACKGROUND

1. Field

The subject matter disclosed herein relates to surveys and more particularly relates to selecting survey questions.

2. Description of the Related Art

Surveys may present questions for gathering information from customers and clients including, for example, information about important aspects of a purchase, service, preferences, or the like. Typically, a survey includes a long set of questions.

### BRIEF SUMMARY

A method for selecting survey questions is disclosed. A response module receives responses to first questions relating to at least two qualities of at least two characteristics. A plot module generates a scatter plot of the at least two qualities for each characteristic. A selection module selects second questions targeted to characteristics with characteristic plot values for the at least two qualities in a specified region of the scatter plot. An apparatus and computer program product also perform the functions of the method.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a drawing illustrating one embodiment of a survey;

FIG. 2 is one embodiment of a plot of characteristic qualities;

FIG. 3 is a schematic block diagram illustrating one embodiment of a computer;

FIG. 4 is a schematic block diagram illustrating one embodiment of a question selection apparatus;

FIG. 5 is a schematic flow chart diagram illustrating one embodiment of a question selection method; and

FIG. 6 is one embodiment of a plot of characteristic qualities with a sized region.

### DETAILED DESCRIPTION OF THE INVENTION

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the computer program product, the payment owed to the service provider is reconciled to the payment owed by the service provider to minimize the transfer of payments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

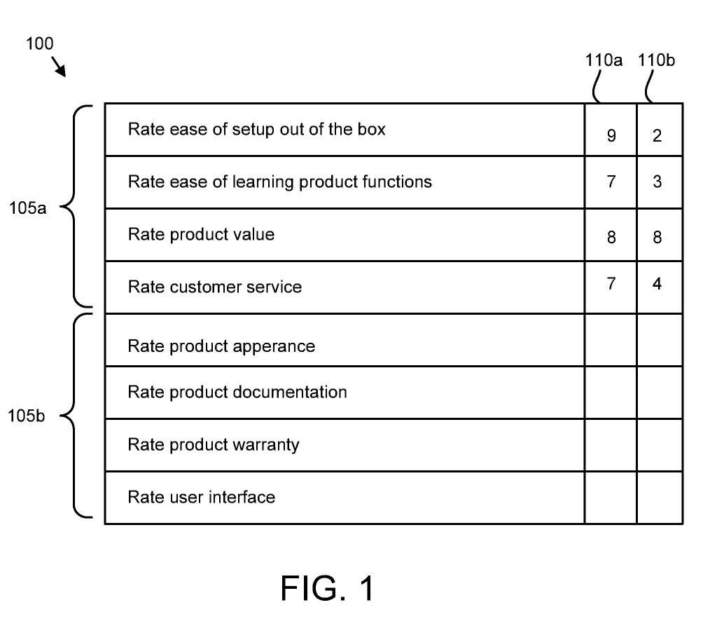

FIG. 1 is a drawing illustrating one embodiment of a survey 100. The survey 100 may be administered to a customer, client, potential customer, potential client, or the like, referred to hereafter as a respondent. In one embodiment, the survey 100 is administered to the respondent to gather data about a purchase and/or service experience.

The survey 100 may be displayed electronically. The survey 100 includes questions 105 and responses 110. The questions 105 may be directed to characteristics of a product and/or service. For example, a question 105 may ask the respondent to rate a customer service experience.

The responses 110 may be directed to a least two qualities of a characteristic described by a question. For example, the question “Rate the ease of set up out of the box” may describe the characteristic out-of-the-box experience.

A first response 110a may be directed to a first quality and a second response 110b may be directed to a second quality. The qualities may include but are not limited to importance, satisfaction, value, lifecycle cost, inter-operability, integration with existing systems, and the like. The responses 110 may comprise numerical scale values. In one embodiment, the numerical scale of each characteristic is equivalent. In addition, the numerical scale of each quality may be equivalent.

In one embodiment, the survey 100 may display first questions 105a. The first questions 105a may be displayed for each respondent. As will be described hereafter, embodiments may select additional second questions 105b for the respondent based on responses to the first questions 105a.

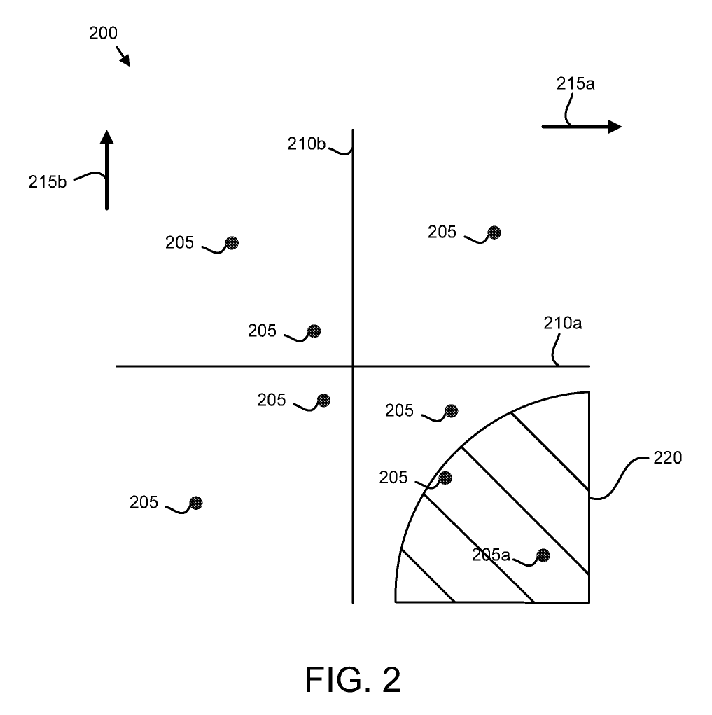

FIG. 2 is one embodiment of a plot 200 of characteristic qualities. The plot 200 may be generated in response to the first questions 105a of FIG. 1. The description of the plot 200 refers to elements of FIG. 1, like numbers referring to like elements.

The plot 200 includes quality axes 210. Each quality axis 210 may quantitatively describe a quality. For example, a first quality axis 210a may quantitatively describe the quality of importance. In addition, a second quality axis 210b may quantitatively describe the quality of satisfaction. In one embodiment, each axis 210 has a direction of increasing value 215. In a certain embodiment, each axis 210 ranges from a value of 1 to a value of 10 with the midpoint of 5.

Although for simplicity the plot 200 is shown with two axes 210, any number of axes 210 may be employed. For example, a four dimensional plot 200 with four axes 210 may be used to evaluate four qualities for each characteristic.

The responses 110 from the survey 100 are plotted on the plot 200 as characteristic plot values 205. For example, a first response 110a of 9 and a second response 110b of 2 may be plotted as a first characteristic plot value 205a.

The plot 200 may include a specified region 220. In one embodiment, the specified region 220 is sized to comprise a specified number of characteristic plot values 205. In the depicted embodiment, the specified region 220 comprises characteristic plot values 205 with high importance and low satisfaction. Alternatively, the specified region 220 may comprise characteristic plot values 205 with high value and low integration with existing systems, low-life cycle cost and high inter-operability, or the like.

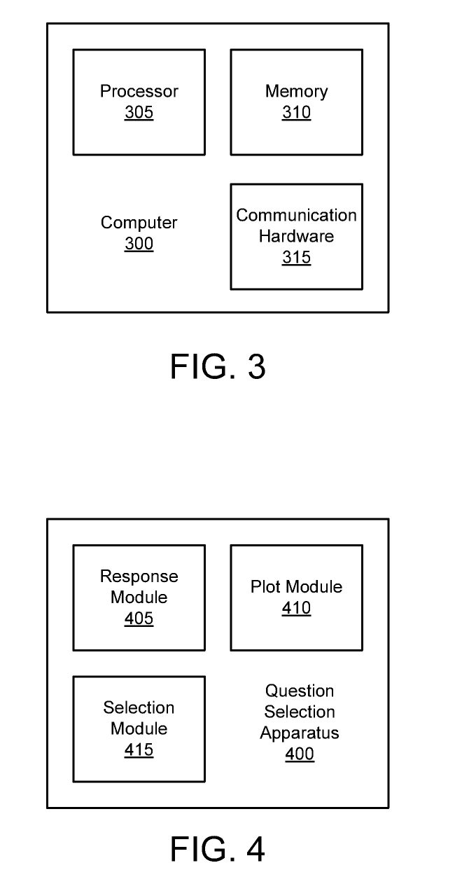

FIG. 3 is a schematic block diagram illustrating one embodiment of a computer 300. The computer 300 may display the survey 100 of FIG. 1 and generate the scatter plot 200 of FIG. 2. The computer 300 includes a processor 305, memory 310, and communication hardware 315. The memory 310 may be a computer readable storage medium. The memory 310 may store computer readable program code. The processor 305 may execute the computer readable program code. The communication hardware 315 may communicate with a respondent, a network, other devices, and the like.

FIG. 4 is a schematic block diagram illustrating one embodiment of a question selection apparatus 400. The apparatus 400 may be embodied in the computer 300 of FIG. 3. The description of the apparatus 400 refers to elements of FIGS. 1-3, like numbers referring to like elements. The apparatus 400 includes a response module 405, a plot module 410, and the selection module 415.

In one embodiment, the response module 405, the plot module 410, and the selection module 415 are embodied in a computer readable storage medium storing computer readable program code. The computer readable program code may be executed by the processor 305.

The response module 405 may receive responses 110 to the first questions 105 relating to a least two qualities of at least two characteristics. The plot module 410 may generate the scatter plot 200 of the at least two qualities for each characteristic. The selection module 415 may select the second questions targeted to characteristics of characteristic plot values for the least two qualities in the specified region 220 of the scatter plot 200.

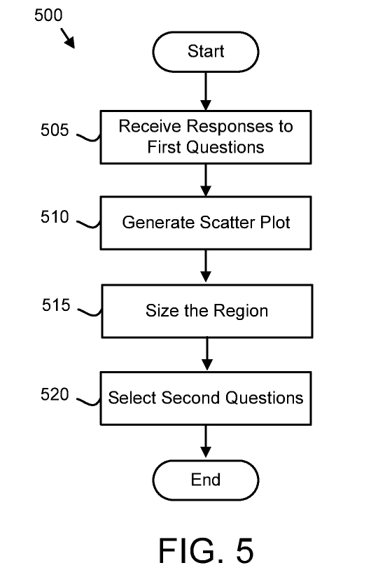

FIG. 5 is a schematic flow chart diagram illustrating one embodiment of a questions selection method 500. The method 500 may perform the functions of the apparatus 400 FIG. 4. The description of the method 500 refers to elements of FIGS. 1-4, like numbers referring to like elements.

In one embodiment, the method 500 is performed by a computer program product comprising a computer readable storage medium. The computer readable storage medium may store computer readable program code executable by the processor 305. The alternatively, the method 500 may be performed by the processor 305.

The method 500 starts, and in one embodiment, the response module 405 receives 505 responses 110 to the first question 105a relating to a least two qualities of at least two characteristics. In one embodiment, the first questions 105a are selected to survey respondent's overall experience. The method 500 may employ the responses 110 to select additional second questions 105b that are most relevant to the respondent's experience.

The plot module 410 may generate 510 the scatter plot 200 of the at least two qualities for each characteristic. In one embodiment, the plot module 410 generates 510 the scatter plot 200 by creating a multidimensional matrix of characteristic plot values 205. Each characteristic plot value 205 may comprise numerical scale values for the qualities of the responses 110. The numerical scale value of each characteristic may be equivalent.

In one embodiment, the plot module 410 sizes 515 the specified region 220 to comprise a specified number of characteristic plot values 205. For example, a selection module 410 may size 515 the specified region 220 to comprise one and only one characteristic plot values 205.

The selection module 415 may select 520 the second questions 105b targeted to characteristics of characteristic plot values 205 for the least two qualities in the specified region 220 of the scatter plot 200 and the method 500 ends. In one embodiment, the sum of the first questions 105a and the second questions 105b is less than a question limit. The question limit may be in the range of 10 to 20 questions.

Continuing the previous example, if the characteristic plot value 205a for the out-of-the-box experience characteristic is in the specified region 220, the selection module 415 may select 520 second questions 105b targeted to the out-of-the-box experience characteristic. In one embodiment, the selection module 415 selects 520 the second questions 105b for characteristic plot values 205 that satisfy Equation 1, where T is a region threshold, each kᵢ is a constant that is not equal to zero, and each xᵢ is a quality value for the ith quality.

Σkᵢ xᵢ>T Equation 1

In one embodiment, the region threshold T is adjusted to comprise a specified number of characteristic plot values 205. For example, T may be adjusted until two characteristic plot values 205 satisfy Equation 1.

The method 500 supports the rapid selection of the second questions 105b targeted to characteristics that are of greatest relevance to the respondent. The length of the survey 100 may be kept below the question limit while thoroughly exploring the experience of the respondent.

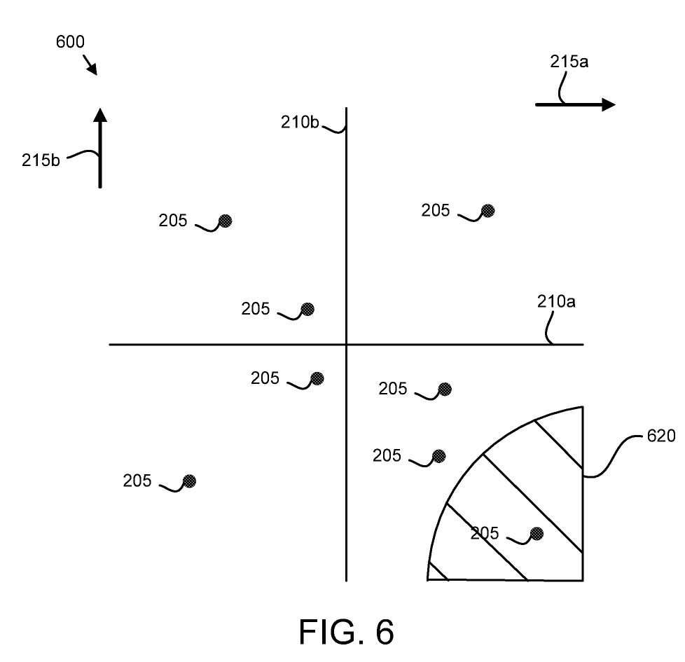

FIG. 6 is one embodiment of a plot 600 of characteristic qualities with sized specified region 620. The plot 600 may be the plot 200 of FIG. 2 with a sized specified region 620. The description of the plot 600 refers to elements of FIGS. 1-5, like numbers referring to like elements.

In the depicted embodiment, the specified region 620 is sized 515 to include a single characteristic plot value 205. By sizing 515 the specified region 620, the number of selected characteristics and selected second questions 105b may be reduced to less than the question limit.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for selecting survey questions comprising:
receiving, by use of a processor, responses to first questions relating to at least two qualities of at least two characteristics;
generating a scatter plot of the at least two qualities for each characteristic; and
selecting second questions targeted to characteristics with characteristic plot values for the at least two qualities in a specified region of the scatter plot.

2. The method of claim 1, wherein a first quality is importance and a second quality is satisfaction.

3. The method of claim 2, wherein the specified region comprises characteristic plot values with high importance and low satisfaction.

4. The method of claim 1, further comprising sizing the specified region to comprise a specified number of characteristic plot values.

5. The method of claim 4, wherein the specified region is sized to a volume with more extreme quality numerical scale values.

6. The method of claim 1, wherein the responses comprise numerical scale values.

7. The method of claim 6, wherein a numerical scale of each characteristic is equivalent.

8. The method of claim 1, wherein a sum of the first questions and second questions is less than a question limit.

9. The method of claim 8, wherein the questions limit is in the range of 10 to 20 questions.

10. An apparatus comprising:
a computer readable storage medium storing computer readable program code executable by a processor, the computer readable program code comprising:
a response module receiving responses to first questions relating to at least two qualities of at least two characteristics;
a plot module generating a scatter plot of the at least two qualities for each characteristic; and
a selection module selecting second questions targeted to characteristics with characteristic plot values for the at least two qualities in a specified region of the scatter plot.

11. The apparatus of claim 10, wherein a first quality is importance and a second quality is satisfaction.

12. The apparatus of claim 11, wherein the specified region comprises characteristic plot values with high importance and low satisfaction.

13. The apparatus of claim 10, the selection module further sizing the specified region to comprise a specified number of characteristic plot values.

14. The apparatus of claim 13, wherein the specified region is sized to a volume with more extreme quality numerical scale values.

15. A computer program product for selecting survey questions, the computer program product comprising:
a computer readable storage medium having computer readable program code embodied therein, the computer readable program code configured to:
receive responses to first questions relating to at least two qualities of at least two characteristics;
generate a scatter plot of the at least two qualities for each characteristic; and
select second questions targeted to characteristics with characteristic plot values for the at least two qualities in a specified region of the scatter plot.

16. The computer program product of claim 15, wherein a first quality is importance and a second quality is satisfaction.

17. The computer program product of claim 16, wherein the specified region comprises characteristic plot values with high importance and low satisfaction.

18. The computer program product of claim 15, the computer readable program code further configured to size the specified region to comprise a specified number of characteristic plot values.

19. The computer program product of claim 18, wherein the specified region is sized to a volume with more extreme quality numerical scale values.

20. The computer program product of claim 15, wherein the responses comprise numerical scale values.
